(19) United States
(12) Patent Application Publication
(10) Pub. No.: US 2013/0263290 A1
(43) Pub. Date: Oct. 3, 2013

(54) ELECTRONIC DEVICE AND HARDWARE COMPONENT PROTECTION METHOD THEREOF

(71) Applicant: Zhen-Wei XU, Shenzhen City (CN)

(72) Inventor: Zhen-Wei XU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/593,531

(22) Filed: Aug. 24, 2012

(30) Foreign Application Priority Data
Mar. 27, 2012 (CN) 201210083680.9

(51) Int. Cl. G06F 21/02

(52) U.S. Cl. 726/34

(57) ABSTRACT

An exemplary hardware component protecting method obtains an identifier inputted by a user. The method outputs an unlocking signal to trigger an electric lock corresponding to one locked hardware component to unlock a case corresponding to the one locked hardware component from the housing when the inputted identifier matches an identifier stored in the locked hardware component. The method also outputs a locking signal to trigger the electric lock corresponding to one newly installed hardware component to lock the case corresponding to the newly installed hardware component to the housing when the identifier stored in the hardware component matches an authorized identifier from a manufacturer's hardware support website.

### BACKGROUND

1. Technical Field

The present disclosure relates to electronic devices and, more particularly, to an electronic device capable of determining whether a user is an authorized user and whether hardware component is an authorized hardware, and a hardware component protection method.

2. Description of Related Art

Hardware items from a computer can easily be stolen. Further, as the need for performance grows, the hardware items of the computer often need to be upgraded. The use of unauthorized or non-authentic hardware may reduce the performance and the stability of the computer. Therefore, a hardware component protection method is needed to resolve the above problems.

### BRIEF DESCRIPTION OF THE DRAWINGS

The components in the drawings are not necessarily drawn to scale, the emphasis instead being placed upon clearly illustrating the principles of the electronic device and the hardware component protection method. Moreover, in the drawings, like reference numerals designate corresponding parts throughout the several views.

FIG. 1 is a view of an electronic device with protected hardware in accordance with an exemplary embodiment.

FIG. 2 is a block diagram of the electronic device of the FIG. 1.

FIG. 3 is a flowchart of a hardware component protection method in accordance with an exemplary embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one”.

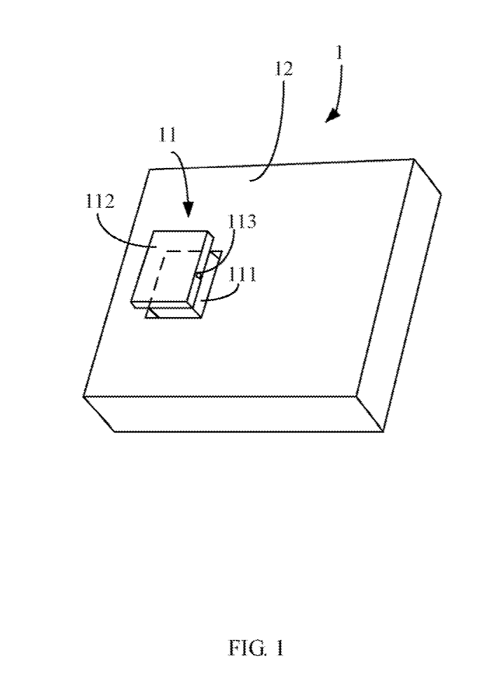

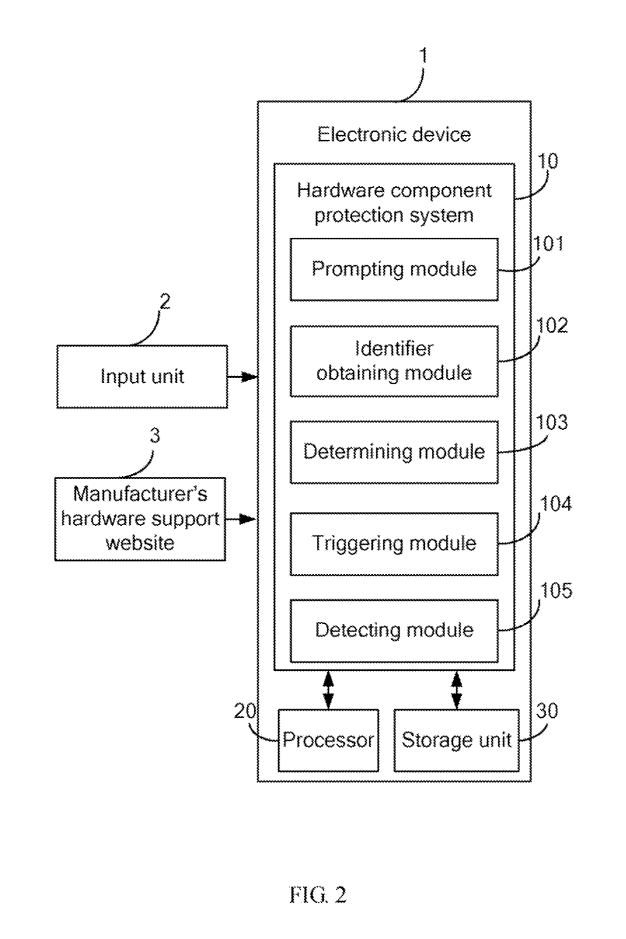

FIGS. 1-2 show an electronic device 1 in accordance with an exemplary embodiment. The electronic device 1 includes a number of hardware units 11 and a housing 12. Each hardware unit 11 includes a hardware component 111, a case 112, and an electric lock 113. The case 112 is fixed to the hardware component 111 and is fixed to the housing 12 through an electric lock 113, thus the hardware component 111 is fixed to the housing 12 through the electric lock 113. The hardware component 111 can be a CPU, or other electronic component of the electronic device 1. Each hardware component 111 stores an identifier. In the embodiment, the identifier is programmed to the hardware component 111. The user can obtain the identifier of the hardware component 111 from the seller or manufacturer when the user buys the hardware component 111. The identifier of the hardware component 111 is to lock/unlock the electric lock 113 corresponding to the hardware component 111. The electronic device 1 is connected to an input unit 2.

The electronic device 1 includes a hardware component protection system 10, a processor 20, and a storage unit 30. In the embodiment, the hardware component protection system 10 includes a prompting module 101, an identifier obtaining module 102, a determining module 103, and a triggering module 104. One or more programs of the above function modules may be stored in the storage unit 30 and executed by the processor 20. In general, the word “module,” as used herein, refers to logic embodied in hardware or firmware, or to a collection of software instructions, written in a programming language. The software instructions in the modules may be embedded in firmware, such as in an erasable programmable read-only memory (EPROM) device. The modules described herein may be implemented as either software and/or hardware modules and may be stored in any type of computer-readable medium or other storage device.

The prompting module 101 invites the user to input the identifier corresponding to one locked hardware component 111 in response to a user request for unlocking a locked hardware component 111.

The identifier obtaining module 102 is to obtain the inputted identifier in response to the user input.

The determining module 103 determines whether the obtained inputted identifier matches the identifier stored in one locked hardware component 111. When the obtained inputted identifier does match the identifier stored in one locked hardware component 111, the triggering module 104 outputs an unlocking signal to trigger the electric lock 113 corresponding to the locked hardware component 111, to unlock the case 112 corresponding to the hardware component 111 from the housing 12, thus the locked hardware component 111 can be taken away from the housing 12 to be maintained or updated by a user.

In a first embodiment, in response to a user request for locking a hardware component 111 newly installed in the electronic device 1, for example, the maintained or updated hardware component 111, the determining module 103 accesses a manufacturer's hardware support website 3 and determines whether the identifier stored in the newly installed hardware component 111 matches one of the authorized identifiers from the manufacturer's hardware support website 3. The manufacturer's hardware support website 3 lists authorized identifiers of each hardware component which can be mounted to the electronic device 1. The electronic device 1 can communicate with the manufacturer's hardware support website 3 through wireless or wired method.

In a second embodiment, the hardware component protection system 10 further includes a detecting module 105. The detecting module 105 detects whether a hardware component 111, for example, the maintained or updated hardware component 111, is newly installed in the electronic device 1. When the detecting module 105 detects that a hardware component 111 is newly installed in the electronic device 1, the determining module 103 accesses the manufacturer's hardware support website 3 and determines whether the identifier stored in the newly installed hardware component 111 matches one of the authorized identifiers from the manufacturer's hardware support website 3.

In another embodiment, the electronic device 1 pre-stores the authorized identifiers from the manufacturer's hardware support website 3 in the storage unit 30, to enable the determining module 103 to directly determine whether the identifier stored in the newly installed hardware component 111 matches a stored authorized identifier without needing to access the manufacturer's hardware support website 3.

When the identifier stored in the newly installed hardware component 111 matches one of the authorized identifiers from the manufacturer's hardware support website 3, namely, the newly installed hardware component 111 is an authorized hardware component, the triggering module 104 outputs a locking signal to trigger the electric lock 113 corresponding to the newly installed hardware component 111 to lock the case 112 to the housing 12, thus the newly installed hardware component 111 is locked in the housing 12.

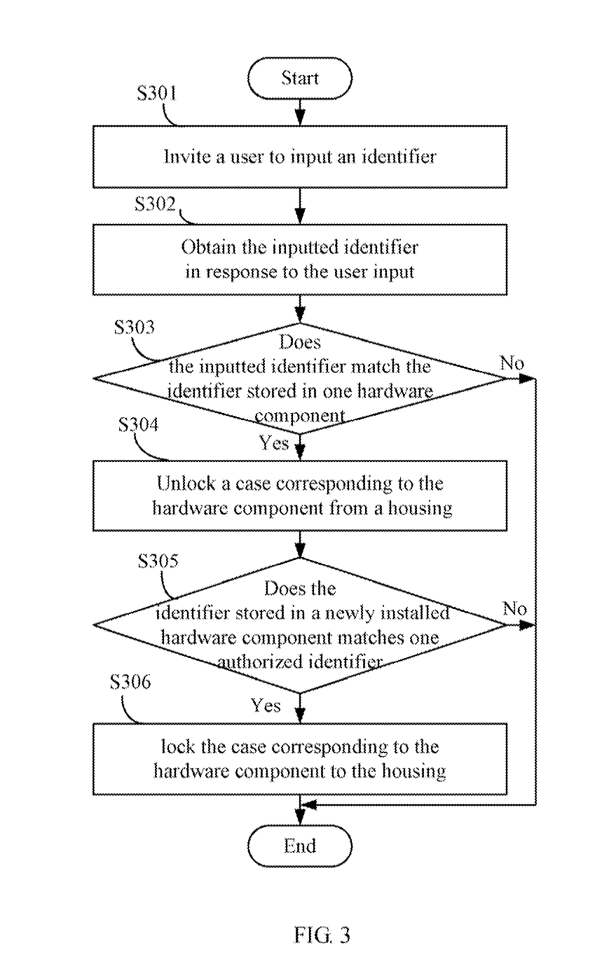

FIG. 3 shows a flowchart of a hardware component protection method in accordance with an exemplary embodiment.

In step S301, the prompting module 101 invites the user to input the identifier corresponding to one locked hardware component 111 in response to a user request for unlocking the one locked hardware component 111.

In step S302, the identifier obtaining module 102 obtains the inputted identifier in response to the user input.

In step S303, the determining module 103 determines whether the inputted identifier matches the identifier stored in one locked hardware component 111. When the inputted identifier matches the identifier stored in one locked hardware component 111, the procedure goes to step S304. When the inputted identifier does not match the identifier stored in one locked hardware component 111, the procedure stops at this step S303.

In step S304, the triggering module 104 outputs an unlocking signal to trigger the electric lock 113 corresponding to the locked hardware component 111 to unlock the case 112 from the housing 12, thus the locked hardware component 111 can be taken away from the housing 12.

In step S305, the determining module 103 determines whether the identifier stored in newly installed hardware component 111, for example, the maintained or updated hardware component 111, matches one of the authorized identifiers stored in the manufacturer's hardware support website 3. In an alternative embodiment, the authorized identifiers are pre-stored in the storage unit 30, the determining module 103 determines whether the identifier stored in the newly installed hardware component 111 matches one of the authorized identifiers stored in the storage unit 30. When the identifier stored in the newly installed hardware component 111 matches one of the authorized identifiers stored in the manufacturer's hardware support website 3 or in the storage unit 30, the procedure goes to step S306. When the identifier stored in the newly installed hardware component 111 matches one of the authorized identifiers stored in the manufacturer's hardware support website 3 or in the storage unit 30, the procedure stops at this step S305.

In step S306, the triggering module 104 outputs a locking signal to trigger the electric lock 113 corresponding to the newly installed hardware component 111 to lock the case 112 to the housing 12, thus the newly installed hardware component 111 is secured in the housing 12.

This electronic device 1 determines whether the inputted identifier matches an identifier stored in one locked hardware component 111, to determine whether the user is authorized. If and only if there is a match, the electric lock 113 corresponding to the locked hardware component 111 unlocks the case 112 from the housing 12. This prevents the unauthorized user from stealing any hardware component 111 of the electronic device 1. The determining module 103 further determines whether the identifier stored in a new or a newly installed hardware component 111 matches one authorized identifier from the manufacturer's hardware support website 3, to determine whether the hardware component is authentic and authorized. Only when there is a match does the electric lock 113 lock the case 112 corresponding to the newly installed hardware component 111 to the housing 12 of the electronic device 1, and this prevents an unauthorized hardware component 111 from being installed in the electronic device 1.

Although the current disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic device comprising:
a housing; and
a plurality of hardware units, each of the hardware units comprising a hardware component, a case, and an electric lock, each of the case being fixed to the corresponding hardware component and operable of being locked or unlocked to the housing through the corresponding electric lock, thereby the corresponding hardware component is locked or unlocked to the housing.

2. The electronic device as described in claim 1, wherein each of the hardware components stores an identifier to lock/unlock the electric lock corresponding to the hardware component.

3. The electronic device as described in claim 2, wherein the electric lock corresponding to one newly installed hardware component locks the case corresponding to the newly installed hardware component to the housing when an identifier stored in the newly installed hardware component matches one authorized identifier from a manufacturer's hardware support website.

4. The electronic device as described in claim 2, further comprising an identifier obtaining module, wherein the identifier obtaining module is to obtain an identifier inputted by a user, the electric lock corresponding to one locked hardware component unlocks the case corresponding to the locked hardware component from the housing when the obtained inputted identifier matches the identifier stored in the locked hardware component.

5. A hardware component protection system implemented by an electronic device, the electronic device comprising a housing and a plurality of hardware units, each of the hardware unit comprising a hardware component, a case, and an electric lock, each of the case being fixed to the corresponding hardware component, each hardware component storing an identifier, wherein the system comprises:
an identifier obtaining module to obtain an identifier inputted by a user; and
a triggering module to output a locking signal to trigger the electric lock corresponding to one newly installed hardware component to lock the case corresponding to the newly installed hardware component to the housing when the identifier stored in the newly installed hardware component matches one authorized identifier from a manufacturer's hardware support website, and further to output an unlocking signal to trigger the electric lock corresponding to one locked hardware component to unlock the case corresponding to the locked hardware component from the housing when the inputted identifier matches the identifier stored in one locked hardware component.

6. The hardware component protection system as described in claim 5 further comprising a prompting module, wherein the prompting module is to invite the user to input the identifier corresponding to the locked hardware component in response to a user request for unlocking the one locked hardware component, the identifier obtaining module is to obtain the inputted identifier in response to the user input.

7. The hardware component protection system as described in claim 5, further comprising a detecting module, wherein the detecting module is to detect whether a hardware component is newly installed in the electronic device, the determining module determines whether the identifier stored in the newly installed hardware component matches one of the authorized identifiers from the manufacturer's hardware support website when a hardware component is newly installed in the electronic device.

8. The hardware component protection system as described in claim 7, wherein the determining module accesses the manufacturer's hardware support website and determines whether the identifier stored in the newly installed hardware component matches one of the authorized identifiers stored in the manufacturer's hardware support website.

9. The hardware component protection system as described in claim 7, wherein the electronic device pre-stores the authorized identifiers from the manufacturer's hardware support website in a storage unit, the determining module directly determines whether the identifier stored in the newly installed hardware component matches a stored authorized identifiers without accessing the manufacturer's hardware support website.

10. The hardware component protection system as described in claim 5, wherein the determining module determines whether the identifier stored in one newly installed hardware component matches one of the authorized identifiers from the manufacturer's hardware support website in response to a user request for locking a hardware component newly installed in the electronic device.

11. The hardware component protection system as described in claim 10, wherein the determining module accesses the manufacturer's hardware support website and determines whether the identifier stored in the newly installed hardware component matches one of the authorized identifiers stored in the manufacturer's hardware support website.

12. The hardware component protection system as described in claim 10, wherein the electronic device pre-stores the authorized identifiers from the manufacturer's hardware support website in a storage unit, the determining module directly determines whether the identifier stored in the newly installed hardware component matches a stored authorized identifiers without accessing the manufacturer's hardware support website.

13. A hardware component protection method implemented in an electronic device, the electronic device comprising a housing and a plurality of hardware units, each of the hardware unit comprising a hardware component, a case, and an electric lock, each of the case being fixed to the corresponding hardware component, each hardware component storing an identifier, wherein the method comprises:
obtaining an identifier inputted by a user; and
outputting an unlocking signal to trigger the electric lock corresponding to one locked hardware component to unlock the case corresponding to the one locked hardware component from the housing when the inputted identifier matches the identifier stored in the locked hardware component, and further outputting a locking signal to trigger the electric lock corresponding to one newly installed hardware component to lock the case corresponding to the one newly installed hardware component to the housing when the identifier stored in the newly installed hardware component matches one authorized identifier from a manufacturer's hardware support website.

14. The hardware component protection method as described in claim 13, wherein the method further comprises:
inviting the user to input the identifier corresponding to the locked hardware component in response to a user request for unlocking the one locked hardware component; and
obtaining the inputted identifier in response to the user input.

15. The hardware component protection method as described in claim 13, wherein the method further comprises:
detecting whether a hardware component is newly installed in the electronic device; and
determining whether the identifier stored in the hardware component matches one of the authorized identifiers from the manufacturer's hardware support website when a hardware component is newly installed in the electronic device.

16. The hardware component protection method as described in claim 15, wherein the method further comprises:
accessing the manufacturer's hardware support website and determining whether the identifier stored in the newly installed hardware component matches one of the authorized identifiers stored in the manufacturer's hardware support website.

17. The hardware component method as described in claim 15, wherein the electronic device pre-stores the authorized identifiers from the manufacturer's hardware support website in a storage unit, the method further comprises:
determining whether the identifier stored in the newly installed hardware component matches one of the authorized identifiers stored in the storage unit without accessing the manufacturer's hardware support website.

18. The hardware component method as described in claim 13, wherein the method further comprises:
determining whether the identifier stored in one newly installed hardware component matches one of the authorized identifiers from the manufacturer's hardware support website in response to a user request for locking a hardware component newly installed in the electronic device.

19. The hardware component method as described in claim 18, wherein the method further comprises:
accessing the manufacturer's hardware support website and determining whether the identifier stored in the newly installed hardware component matches one of the authorized identifiers stored in the manufacturer's hardware support website.

20. The hardware component method as described in claim 18, wherein the electronic device pre-stores the authorized identifiers from the manufacturer's hardware support website in a storage unit, the method further comprises:
determining whether the identifier stored in the newly installed hardware component matches one of the authorized identifiers stored in the storage unit without accessing the manufacturer's hardware support website.
